(19) United States
(12) Patent Application Publication
(10) Pub. No.: US 2010/0207937 A1
(43) Pub. Date: Aug. 19, 2010

(54) SYSTEM FOR CREATING A PERSONALISED 3D ANIMATED EFFIGY

(76) Inventor: Anthony James Trothe, Everton Park (AU)

Correspondence Address: ANTHONY TROTHE;CATHERINE BRIDGE, 914 South Pine Road, Everton Park, 4053, omitted

(21) Appl. No.: 12/374,541

(22) PCT Filed: Jul. 23, 2007
(86) PCT No.: PCT/AU2007/001021

§ 371 Date: Jan. 21, 2009

(30) Foreign Application Priority Data
Jul. 21, 2006 (AU) 2006903944

(51) Int. Cl. G06T 15/00

(52) U.S. Cl. 345/419; 345/473

(57) ABSTRACT

A system for creating a personalized 3D animated effigy, wherein the system comprises a web server configured to receive personal configuration data from a user interface and a production server configured to create the personalized 3D aminated effigy, wherein personal configuration data received by the web server is processed by the production server to create a whole body model of the personalized 3D animated effigy in combination with a 3D background.

### FIELD OF THE INVENTION

The invention relates to a system for creating a personalized 3D animated effigy. In particular, although not exclusively, the invention relates a system for creating a personalized 3D animated effigy to identify a user from his mobile device.

### BACKGROUND TO THE INVENTION

Recent advances in mobile network technologies and its multimedia capability coupled with the emergence of reliable standards in mobile devices has given consumers the ability to personalize their mobile devices. This has led to a growing market in mobile device ring tones that consumers may purchase and download to their mobile devices.

Universal Mobile Telecommunications System (UMTS) is one of the third generation or 3G mobile network technologies that offer significantly faster mobile personal configuration data rates than older GPRS (also known as 2.5G) technologies, allowing for the transfer of richer media content such as movies, video telephony and interactive web sites to video capable mobile devices.

The adoption of 3G mobile network technologies provides consumers with the opportunity to customize their mobile devices with content that was not available with previous mobile network technologies. For example, 3G capable mobile devices allow consumers to send and receive animated ring tones.

However, 3D animated effigies cannot be personalized by the average consumer due to the high cost of required software tools and the technical skills and knowledge required to operate them. An animated ring tone has to be carefully scripted to overcome the issues of aggressive compression techniques, small screen resolution, limited colour range and slow frame rate of current 3G capable mobile devices.

Accordingly, only studios employing highly skilled animators and technicians have been able to produce animated ring tones (eg ‘Crazy Frog’) such that personalization of 3D animated effigies is not readily available as a product to the majority, of consumers.

### OBJECT TO THE INVENTION

It is an object of the invention to at least ameliorate the disadvantages and shortcomings of the prior art, or at least provide the public with a useful alternative.

### SUMMARY OF THE INVENTION

In one form, although it need not be the only, or indeed the broadest form, the invention resides in a system for creating a personalized 3D animated effigy to identify a user of a mobile device, wherein the system comprises:

a web server configured to receive personal configuration data from a user interface; and

a production server configured to create the personalized 3D animated effigy;

wherein the personal configuration data received by the web server is processed by the production server to create a whole body model of the personalized 3D animated effigy in combination with a 3D background which is then delivered to the mobile device of the user to create a personalized 3D animated effigy of the user.

Preferably, the personal configuration data includes both of the following:

i) upper body type; and

ii) lower body type.

Preferably, the personal configuration data includes a 3D facial model.

Preferably, the personal configuration data includes one or more of the following:

iii) shoe type;

iv) eye type;

v) teeth type;

vi) skin appearance;

vii) accessory type;

viii) audio type;

ix) body animation; and

x) facial animation.

Preferably, the personal configuration data includes one or more of the following;

xi) custom scene;

xii) environmental effects;

xiii) audio effects; and

xiv) text.

Preferably, the web server comprises an effigy content management system module and an effigy configurator module.

The scene files module 105 contains a number of scene files to construct each of the preset 3D animated body models. Each scene file has a set of scene rules associated with it that are stored by the scene rules module 106. The effigy content management system module 104 interrogates the scene rules module 106 to determine the inventory files 107 that are required to be loaded into an effigy configurator module 110 to customize the preset 3D animated body model.

The inventory personal configuration database contains all the inventory files that are used for the construction of each preset 3D animated body model.

The costing data module 108 provides costing data for each inventory file applied to the animated effigy.

The promotion data module 109 allows the system to be used for advertising or promoting products or events. The promotion data module 109 contains promotion data concerning inventory files that are sponsored by various companies or organizations. Selecting a sponsored inventory file will reduce the overall cost of customizing the preset 3D animated body model by influencing the costing data.

An effigy configurator module 110 allows for graphical interactive selection of all the options and features which make up the preset 3D animated body model. The effigy configurator module 110 comprises a menu and selection rules module 111, a preview user selections module 112, a record user selections module 113, and a tally costs module 114.

The effigy configurator module 110 creates a user interface by loading the scene rules from the effigy content management system module 104 into the menu and selection rules module 111. The menu and selection rules module 111 determines the menus and options that will be presented in the user interface that the user may interact with to customize the preset 3D animated body model.

Inventory files 107 are loaded into the preview user selections module 112. The preview user selections module 112 allows the user to select an inventory file to apply to the preset 3D animated body model and preview the result in an interactive manner.

The record user selections module 113 is used to compile a record of the selections the user has made to the animated effigy. Each preset 3D animated body model has an initial default inventory file attributed to each of its selectable options when it is initially loaded by the effigy configurator module 110.

The tally costs module 114 dynamically shows costs as selectable options are changed by referencing the costing data and promotion data and displaying the total cost in real time.

When the user has finished modifying the preset 3D animated body model and decides to order the animation the effigy configurator module 110 compiles the selections into an order using an order module 115. The order module 115 creates an order page where the cost of the order is confirmed by the user.

The order page prompts the user to upload a photo and voice recording file 116. The uploaded photo and voice recording files are tested by a test module 117 to ensure the files can be integrated into the customized animated effigy. The test module 117 then creates thumbnails of the uploaded photos and then sends the thumbnail photos back to the order module where they are presented to the user in the order page.

An options module 118 creates a list of optional products which the user can select and configure using the order page. The optional products include, by are not limited to, effigy Email signature animation, video AVI large format animation for video and web sites, chroma keyed animations for video titling and overlay, web site animations, 3D avatars, large size single frame caricatures, and delivery method options including SMS, WAP or email.

The user selects the optional products and optional delivery methods using the order page. A customer confirmation module 119 is provided that presents a number of terms and conditions that the user must agree to that confirms that the provider takes no legal responsibility for the images that is uploaded to the system.

The user selects a payment method that is presented using a payment systems module 120. The user is then presented with the member signup screen where the user enters personal details for the order.

At this time a server routine assigns a unique order ID for the user and updates a user personal configuration database with the user's details. An order assembly module 121 is provided that assembles the order personal configuration data and personal details into a highly formatted personal configuration data record. The personal configuration data record has a very rigid personal configuration data format which is a mix of personal configuration database update commands and personal configuration data transfer routines.

The financial reporting module 204 reports on inventory file utilization and sales percentages. This will allow the operator to fine tune the inventory files to user demand.

When order personal configuration data is transferred from the web server to the production server, a synchronization module 205 sends the personal configuration data to a transfer user files module 206 and updates the job status and control system module 202 to status code CS1.

The transfer customer files module 206 sends the order personal configuration data to the user file store module 201 which creates a unique user file store where photos and voice personal configuration data supplied by the user are stored. The job status and control system module 202 is updated with a status code CS2.

An order confirmation module 207 is provided to verify the order personal configuration data and creates an email which re-iterates the order details in a template format that is mailed to the user as an order confirmation. Because the system is fully integrated with the job status and control system module 202 it is able to forward schedule the workload already in the system and advises the user of an expected processing time for their order. It then updates the job status and control system module 202 with a status code of CS3.

At this point order personal configuration data is either processed by a manual processing module 208 or an automatic processing module 209.

The manual processing module 208 is based on 3D software package from Reallusion in Taiwan called ICLONE. The 3D engine contains modules that allow for the conversion of 2D photos to 3D head by a skilled animator. Both portrait and profile photographs are used to create the 3D head. Any orders containing only portrait photos are sent to the manual processing module 208, while orders containing portrait and profile photos are sent to the automatic processing module 209.

The automatic processing module 209 is designed to cope with approximately 85% of order personal configuration data with the remaining 15% being set aside for the manual processing module 208 where the animation is complex or the face is difficult to fit automatically.

An image pre-process user files module 210 is provided in the automatic processing module 209 to check the image boundary and image size of the user's facial portrait and facial profile to ensure each image is suitable to create a 3D image of the user's face.

If the images fail this test the job status and control system module 202 creates an email notice to the user to re-submit the images. Depending on the result for image size test the image is rescaled to the correct size by an automated routine. This will shrink and oversize photo to a preset size while maintaining the aspect ratio of the original photo. The job status and control system module 202 is updated with a status code CS4.

An audio pre-processing module 211 is provided if the user has optioned to have a voice recording to be lip-synched with the animation. The audio pre-processing module 211 first tests that a voice file exists in the user file store module 201. The job status and control system module 202 then rechecks the file length of the voice recording against the animation scene file length. The voice file time in seconds should always be shorter than the animation file.

A user's head model is also kept on file so that the user can order further animations without having to submit more photographs for the head model. The timeout process set the storage date flags for the files so that if a user does not use the files after a pre-scribed time, the files will be archived off the production server to a long term storage server or be erased.

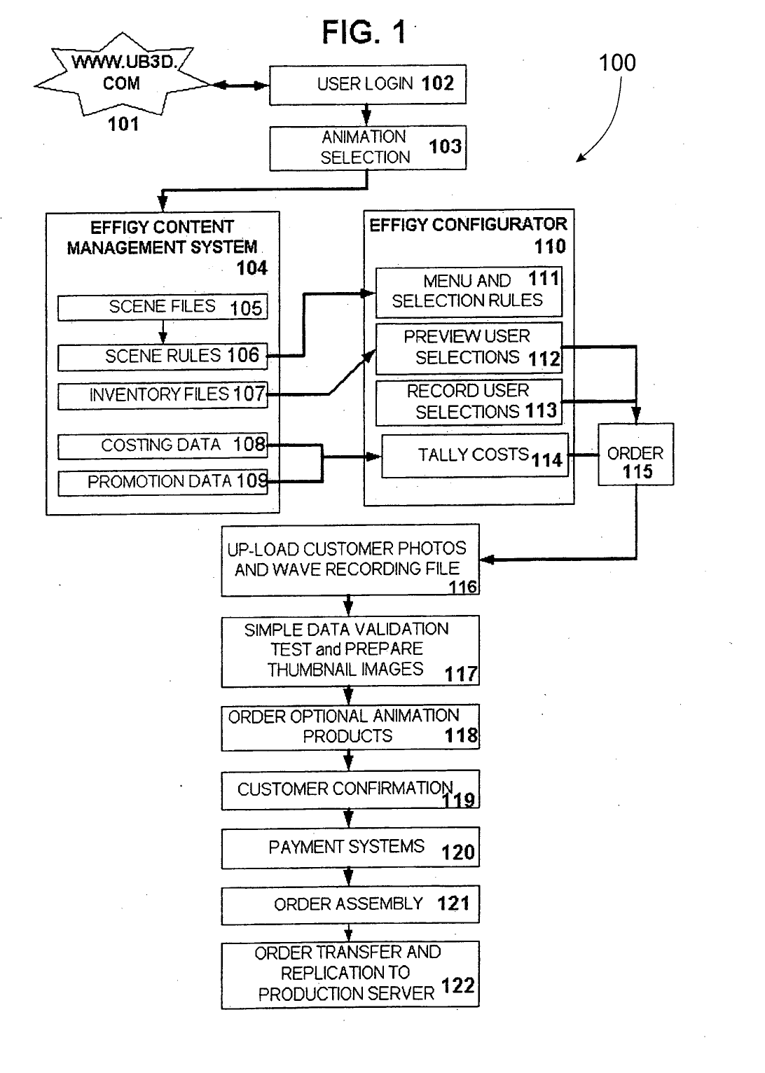

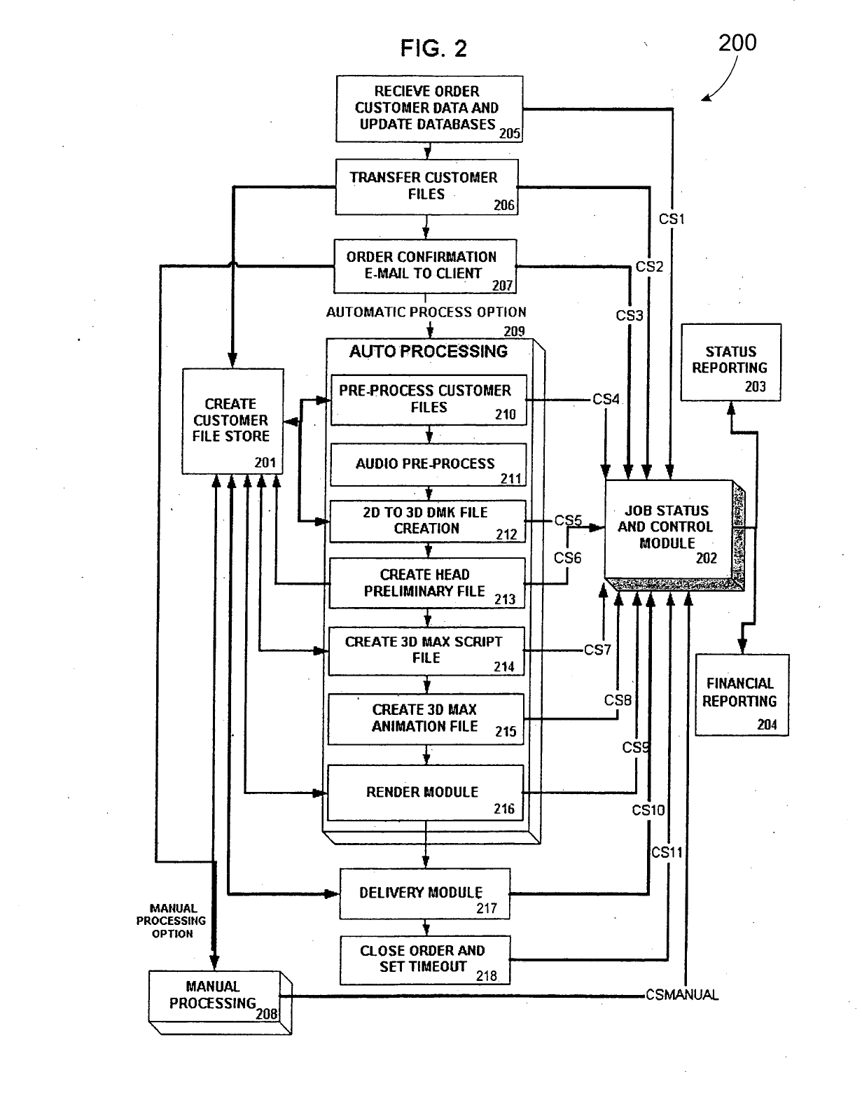

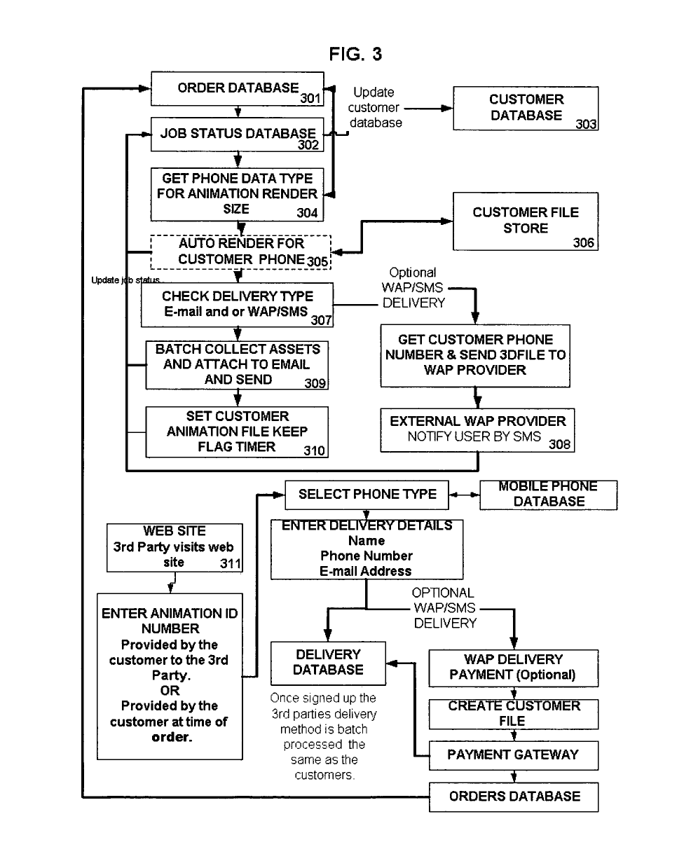

FIG. 3 shows the delivery process 300 of the delivery module 217 of FIG. 2 delivering the personalized 3D animated effigy to a user and a third party, respectively.

An order personal configuration database module 301 checks the job status personal configuration database module 302 to confirm the order has been processed and obtains order personal configuration data from a customer personal configuration database module 303 to get the delivery options entered by the user when the order was confirmed during the web server process 100.

The user's mobile device model is retrieved from the order personal configuration data and is cross matched by a mobile device personal configuration database module 304 so the personalized 3D animated effigy can be re-rendered to suit the user's particular mobile device.

The personalized 3D animated effigy is re-rendered by a render module 305 to output dimensions in pixels as per the mobile model type and saves this animation in the users file store 306.

A delivery module 307 checks the delivery preferences and retrieves the user's mobile phone number from the user file store 306. The delivery module 307 then sends the personalized 3D animated effigy and the phone

Another option is to allow the third parties to become members and to make a small payment so that they may receive the user's personalized 3D animated effigy by SMS or WAP delivery methods.

If the third party proceeds with the order they are transferred to a payment gateway where they will select their payment type and enter transaction details. The transaction details are confirmed by the financial gateway provider and a transaction code is added to the user personal configuration database records.

The payment is validated by the financial gateway and the user is advised of the transaction and the order number on the screen. The orders personal configuration database is then updated with all the personal configuration data and the order and personal configuration data is transferred to the production server at head office. The production server sends an E-mail confirmation of the order to the user once it has been logged into our production system.

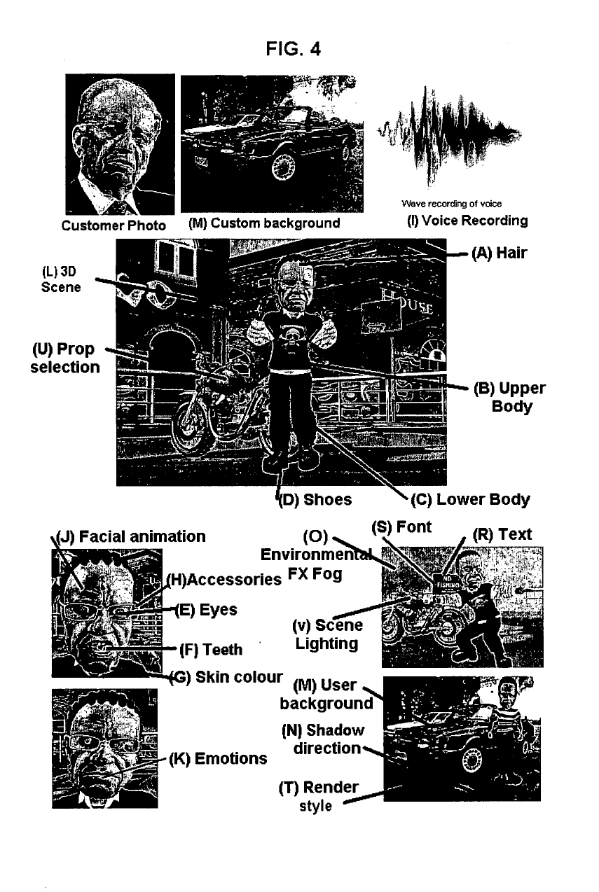

FIG. 4 shows a number of selectable options available to the user to customize the personalized 3D animated effigy.

Selectable options are applied as either personal configurations to alter the preset 3D animated body model or scene configurations to alter environment that the preset 3D animated body model is to be presented.

Personal configuration may include:
(A) Hair type and styles and colour;
(B) Upper body type—shirt, armour, Guernsey. Tee shirt, singlets, jacket etc;
(C) Lower body type—Shorts, suit pants, skirt, Football shorts and socks;
(D) Shoe type—Boots, high heels;
(E) Eye type and colour—Real eyes as per their photo or custom eyes, which can incorporate, changing the colour, shape, type. i.e. Cats eyes, vampire eyes, monster eyes etc;
(F) Teeth type—They can select their teeth from a preset range of teeth templates which can include Vampire teeth, broken teeth, buck teeth etc;
(G) Skin appearance—including colour, tattoos, scars, wounds, body piercing etc;
(H) Select Accessories—such as watches, sunglasses, jewelry, guns, tools, helmets, hats, sporting equipment etc;
(I) Nominate if they want to use wave file for synching to their Character;
(J) Select motions for their characters—the movement that the character enacts, kick a ball, dance, fight, fall over or combinations thereof; and
(K) Select facial animation such as emotions—Laugh, sad, angry, smile etc.

Scene configuration may include:
(L) Select their background 3d scene;
(M) User may provide their own custom background for the animation scene—such as a digital photo, picture etc;
(N) Select the shadow direction for their custom background (M);
(O) Select environmental FX like lightning, fog, rain, snow, steam etc;
(P) Select music background—choice of music backgrounds;
(Q) Select sound FX like car horns, heavy machinery, thunder, explosions etc;
(R) Select text to be displayed—Their name, a catchphrase, a message etc;
(S) Select the text typeface and animation style;
(T) Choice of render style, real 3d, cartoon outline, toon, Machima etc;
(U) Choice of background props such as Cars, motorbikes, buildings, equipment, furniture etc;
(V) Select the scene lighting types and colours, Red light, flashing disco lights, sunlight, moonlight, strobe lights etc; and
(W) Select video background to be inserted into the animation. This could be a video clip shown on a TV set, a popular music video clip, a section from a movie etc.

The invention provides a fully integrated animation production and delivery system to allow non technical consumers to design and order a personalized 3D animated effigy of themselves that would normally be very difficult for a consumer to create via a simple, understandable user interface. The invention also provides a fast turnaround time in the creation of personalized animated effigies when compared to conventional animation suppliers. The invention also allows users to store existing files to reuse for creating additional personalized animated effigies.

Throughout the description and claims of this specification, the word “includes” and variations of that word such as “including” are not intended to exclude other additives, components, integers or steps.

Throughout the specification the aim has been to describe the invention without limiting the invention to any one embodiment or specific collection of features. Persons skilled in the relevant art may realize variations from the specific embodiments that will nonetheless fall within the scope of the invention.

1. A system of creating a personalized 3D animated effigy to identify a user of the mobile device, wherein the system comprises:
a web server configured to receive personal configuration data from a user interface; and
a production server configured to create the personalized 3D animated effigy;
wherein personal configuration data received by the web server is processed by the production server to create a whole body model of the personalized 3D animated effigy in combination with a 2D or 3D background which is then delivered to the mobile device of the user to create a personalized 3D animated effigy of the user.

2. A system as claimed in claim 1, wherein said personal configuration data includes both of the following:
i) upper body type; and
ii) lower body type.

3. A system as claimed in claim 1, wherein said personal configuration data includes a 3D facial model.

4. A system as claimed in claim 1 or 2, wherein said personal configuration data includes one or more of the following:
iii) shoe type;
iv) eye type;
v) teeth type;
vi) skin appearance;
vii) accessory type;
viii) audio type;
ix) body animation; and
x) facial animation.

5. A system as claimed in any of claims 1 to 3, wherein said personal configuration data includes one or more of the following;
xi) custom scene;
xii) environmental effects;
xiii) audio effects; and
xiv) text.

6. The system as claimed by claim 1, wherein the web server comprises an effigy content management system module and an effigy configurator module.

7. The system as claimed by claim 6, wherein the effigy content management system module determines one or more selectable options to be displayed by the effigy configurator to create the personalized 3D animated effigy.

8. The system as claimed by claim 6, wherein the effigy content management system module comprises a scene files module, a scene rules module, and an inventory files module.

9. The system as claimed by claim 8, wherein the scene files Module interrogates the scene rules module to extract personal configuration data from the inventory files module regarding the selectable options.

10. The system as claimed by claim 6, wherein the effigy content management system module comprises a costing data module and a promotion data module.

11. The system as claimed by claim 10, wherein the costing data module provides costing data for each inventory file that is applied to the personalized 3D animated effigy.

12. The system as claimed by claim 10, wherein the promotion data module provides promotion data for each inventory file to influence the costing data obtained from the costing database.

13. The system of the claim 2, wherein the production server comprises an automatic processing module adapted to integrate one or more software modules to process personal configuration data and create the personalized 3D animated effigy.

14. A method of creating a personalized 3D animated effigy of a user of a mobile device which includes the steps of:
(i) receiving personal configuration data of the user at a web server configured to receive said personal configuration data of the user from a user interface;
(ii) forwarding the personal configuration data of the user to a production server whereby said data is processed by the production server to create a whole body model of the personalized 3D animated effigy in combination with a 2D or 3D background; and
(iii) Delivering the whole body model of the personalized 3D animated effigy in combination with the 2D or 3D background to the mobile device belonging to the user to create a unique identity of the user.
